(19) United States
(12) Patent Application Publication
(10) Pub. No.: US 2022/0271882 A1
(43) Pub. Date: Aug. 25, 2022

(54) Spatial Relation Configuration and Indication for Pucch Resources

(71) Applicant: Lenovo (Beijing) Limited, Beijing (CN)

(72) Inventors: Bingchao Liu, Changping District (CN); Chenxi Zhu, Haidian District (CN); Lianhai Wu, Chaoyang (CN); Lingling Xiao, Haidian District (CN)

(73) Assignee: Lenovo (Beijing) Limited, Beijing (CN)

(21) Appl. No.: 17/630,852

(22) PCT Filed: Aug. 2, 2019
(86) PCT No.: PCT/CN2019/099009

§ 371 Date: Jan. 27, 2022

(51) Int. Cl. H04L 5/00; H04W 72/04

(52) U.S. Cl. CPC H04L 5/0023; H04W 72/046

(57) ABSTRACT

Methods and apparatuses for configuring and indicating spatial relation for PUCCH resources are disclosed. A method comprises configuring the number of PUCCH resources sharing a same PUCCH-spatialRelationInfo value, wherein the number is one or more; and transmitting a MAC CE to indicate one spatialRelationInfo value for the one or more PUCCH resources.

### FIELD

The subject matter disclosed herein generally relates to wireless communications, and more particularly relates to spatial relation configuration and indication for PUCCH resources.

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), New Radio (NR), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Next Generation Node B (gNB), Orthogonal Frequency Division Multiplexing (OFDM), Radio Resource Control (RRC), Reference Signal (RS), Time-Division Duplex (TDD), Time Division Multiplex (TDM), User Entity/Equipment (Mobile Terminal) (UE), Uplink (UL), Universal Mobile Telecommunications System (UMTS), Internet-of-Things (IoT), Narrowband Internet-of-Things (NB-IoT or NBIoT), Long Term Evolution (LTE), Narrowband (NB), Physical Downlink Shared Channel (PDSCH), Physical Uplink Shared Channel (PUSCH), Physical Uplink Control Channel (PUCCH), Downlink control information (DCI), Physical Resource Block (PRB), Universal Mobile Telecommunications System (UMTS), Evolved-UMTS Terrestrial Radio Access (E-UTRA or EUTRA), Media Access Control (MAC), Control Element (CE), Bandwidth Part (BWP), Logical Channel ID (LCID), Technical specification (TS).

In Release 15, a UE can be configured up to 128 PUCCH resources in a carrier. A PUCCH resource can be configured with one spatial relation by a MAC CE to indicate the transmit beam for this PUCCH resource. The one spatial relation is selected from up to eight (8) possible spatial relations configured to the UE. The spatial relation is configured by a higher layer parameter PUCCH-spatialRelationInfo. In particular, one of 8 PUCCH-spatialRelationInfo in a BWP can be activated for one PUCCH resource by a PUCCH spatial relation Activation/Deactivation MAC CE. The PUCCH spatial relation Activation/Deactivation MAC CE is identified by a MAC PDU sub-header with a dedicated LCID.

FIG. 1 illustrates a structure of PUCCH spatial relation Activation/Deactivation MAC CE of Release 15.

As shown in FIG. 1, the PUCCH spatial relation Activation/Deactivation MAC CE has a fixed length of 24 bits. In FIG. 1, each Oct (Oct 1, Oct 2 or Oct 3) includes 8 bits. The following fields are included:

(1) Serving Cell ID: This field indicates the identity of the Serving Cell for which the MAC CE applies. The length of this field is 5 bits.

(2) BWP ID: This field indicates a UL BWP for which the MAC CE applies. The length of the BWP ID field is 2 bits.

(3) PUCCH Resource ID: This field contains an identifier of the PUCCH resource ID identified by PUCCH-ResourceId as specified in TS 38.331 [5]. The length of the field is 7 bits.

(4) Sᵢ: If there is a PUCCH Spatial Relation Info with PUCCH-SpatialRelationInfoId i as specified in TS 38.331 [5] configured for the uplink (UL) bandwidth part (BWP) indicated by BWP ID field, Sᵢ indicates the activation status of PUCCH Spatial Relation Info with PUCCH-SpatialRelationInfoId i. Each of the Sᵢ fields (i.e. S₀-S₇) may be set to “1” to indicate PUCCH Spatial Relation Info with PUCCH-SpatialRelationInfoId i should be activated, or set to “0” to indicate PUCCH Spatial Relation Info with PUCCH-SpatialRelationInfoId i should be deactivated. Only a single PUCCH Spatial Relation Info can be active for a PUCCH Resource at a time. If the PUCCH Spatial Relation Info with PUCCH-SpatialRelationInfoId i is not specified in TS 38.331 [5] configured for the uplink bandwidth part indicated by BWP ID field, MAC entity shall ignore this particular Sᵢ.

(5) R: Reserved bit. Each of the reserved bits is set to “0”.

It can be seen from FIG. 1 that each PUCCH resource (identified by a PUCCH Resource ID) is separately indicated, by a PUCCH spatial relation Activation/Deactivation MAC CE, with one of 8 PUCCH-spatialRelationInfo (one of S₀-S₇ is set to “1” while the others of S₀-S₇ is set to “0”). Therefore, multiple MAC CEs are required to indicate or update the spatial relation for multiple PUCCH resources although they may share the same spatial relation.

In addition, it has been agreed to increase the maximum number of spatial relations for PUCCH from 8 to 64 per BWP configured for one UE. In this condition, if the structure of PUCCH spatial relation Activation/Deactivation MAC CE illustrated in FIG. 1 is used, the bits for the field “Sᵢ” would have also to increase from 8 to 64, which means that the length of the PUCCH spatial relation Activation/Deactivation MAC CE would increase to 80 bits.

If multiple PUCCH resources that share the same spatial relation can be indicated or updated together, the number of PUCCH spatial relation Activation/Deactivation MAC CEs would be decreased significantly. In addition, since only one of “Sᵢ” fields is set to “1” while the other “Sᵢ” fields are set to 0, it is enough to only indicate the number “i” of the “Sᵢ” field that is to be set to “1”.

It is therefore an object of the present invention to provide methods and apparatuses to implement configuration and indication of spatial relation for a PUCCH group.

### BRIEF SUMMARY

Methods and apparatuses for configuring and indicating spatial relation for PUCCH resources are disclosed.

In one embodiment, a method comprises configuring the number of PUCCH resources sharing a same PUCCH-spatialRelationInfo value, wherein the number is one or more; and transmitting a MAC CE to indicate one PUCCH-spatialRelationInfo value for the one or more PUCCH resources.

In one embodiment, each PUCCH resource is indicated by a 7-bit or 8-bit field in the MAC CE.

In another embodiment, the method further comprises configuring one or more PUCCH groups including the one or more PUCCH resources, wherein each PUCCH resource is indicated with 1 bit in the MAC CE. In particular, when two or more PUCCH groups are configured, the MAC CE includes a PUCCH group ID field to indicate the identity of the PUCCH group for which the MAC CE applies

In some embodiment, each PUCCH resource is indicated with a PUCCH group ID and 1 bit in the MAC CE, wherein the PUCCH group ID indicates a PUCCH group, and the 1 bit indicates the PUCCH resource ID within the PUCCH group.

In some embodiment, the MAC CE contains a Serving Cell ID field with 5 bits, a BWP ID field with 2 bits, and a PUCCH-spatialRelationInfo ID field with 6 bits.

In one embodiment, a base unit comprises a processor that configures the number of PUCCH resources sharing a same PUCCH-spatialRelationInfo value, wherein the number is one or more; and a transmitter that transmits a MAC CE to indicate one PUCCH-spatialRelationInfo value for the one or more PUCCH resources.

In another embodiment, a method comprises receiving a MAC CE to indicate a PUCCH-spatialRelationInfo value for one or more PUCCH resources, wherein the one or more PUCCH resources are configured to share the same PUCCH-spatialRelationInfo value.

In yet another embodiment, a remote unit comprises a receiver that receives a MAC CE to indicate a PUCCH-spatialRelationInfo value for one or more PUCCH resources, wherein the one or more PUCCH resources are configured to share the same PUCCH-spatialRelationInfo value.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates prior art PUCCH spatial relation Activation/Deactivation MAC CE;

FIG. 2 illustrates an example of the PUCCH group spatial relation Activation/Deactivation MAC CE according to a first embodiment;

FIG. 3 illustrates an example of the PUCCH group spatial relation Activation/Deactivation MAC CE according to a second embodiment;

FIG. 4 illustrates an example of the PUCCH group spatial relation Activation/Deactivation MAC CE according to a third embodiment;

FIG. 5 is a schematic flow chart diagram illustrating an embodiment of a method for configuring and indicating spatial relation for a PUCCH group;

FIG. 6 is a schematic flow chart diagram illustrating a further embodiment of a method for configuring and indicating spatial relation for a PUCCH group; and

FIG. 7 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

A PUCCH group can be defined as a set of PUCCH resources that all share the same value of PUCCH-spatialRelationInfo. According to a first embodiment, the PUCCH group is implicitly defined.

According to the first embodiment, a PUCCH group spatial relation Activation/Deactivation MAC CE defines both the PUCCH resources in the group and the value of PUCCH-spatialRelationInfo of the PUCCH resources within this group. The PUCCH group spatial relation Activation/Deactivation MAC CE may be identified by a MAC PDU sub-header with a dedicate LCID.

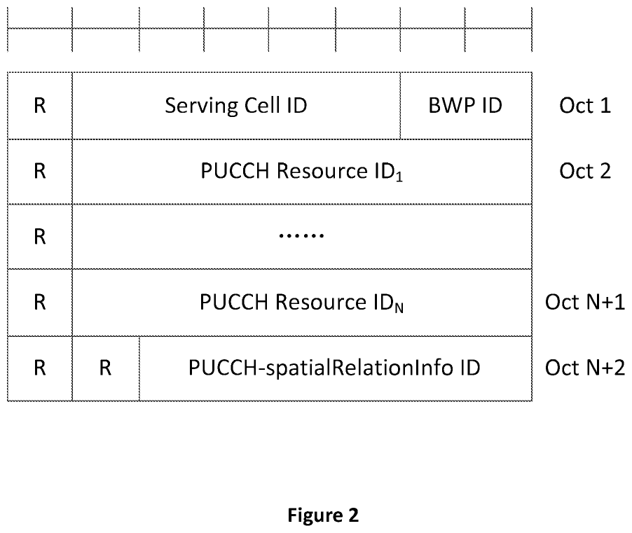

An example of the PUCCH group spatial relation Activation/Deactivation MAC CE according to the first embodiment is illustrated in FIG. 2. The following fields are included:

(1) Serving Cell ID: This field indicates the identity of the Serving Cell for which the MAC CE applies. The length of the field is 5 bits.

(2) BWP ID: This field indicates a UL BWP for which the MAC CE applies. The length of the BWP ID field is 2 bits.

(3) PUCCH Resource IDᵢ: This field indicates the i^{th} PUCCH resource of the PUCCH group. Each Oct (Oct 2 to Oct N+1) contains an identifier of the PUCCH resource ID (PUCCH resource ID₁ to PUCCH resource ID_{N}) identified by pucch-ResourceId as specified in TS 38.331. The length of each of the PUCCH Resource IDᵢ field is 7 bits. The total length of the field is 7*N, in which N is the number of PUCCH resource IDs sharing the same value of PUCCH-spatialRelationInfo.

(4) PUCCH-spatialRelationInfo ID: this field indicates the identity of PUCCH-spatialRelationInfoId as specified in TS 38.331 activated for the listed PUCCH resources. The length of this field is 6 bits. As mentioned above, it has been agreed to increase the maximum number of spatial relations for PUCCH from 8 to 64 per BWP for one UE. In addition, only a single PUCCH-spatialRelationInfo can be active for a PUCCH Resource at a time. Therefore, a 6-bits field is enough to indicate one of 64 spatial relations (i.e. the spatial relation to be indicated).

(5) R: Reserved bit. Each of the reserved bits is set to “0”.

As can be seen from FIG. 2, each of Oct 2 to Oct N+1 contains PUCCH resource ID field of 7 bits and one reserved bit. It is obvious that a 7-bits PUCCH resource ID field can indicate 128 PUCCH resources. Alternatively, if all of 8 bits contained in each of Oct 2 to Oct N+1 are used to indicate PUCCH resources, 256 PUCCH resources can be indicated.

According to the first embodiment, all of PUCCH resource IDs (PUCCH resource ID₁ to PUCCH resource ID_{N}) sharing the same value of PUCCH-spatialRelationInfo (identified by PUCCH-spatialRelationInfo ID) can be indicated or updated with one PUCCH group spatial relation Activation/Deactivation MAC CE at a time.

The PUCCH group spatial relation Activation/Deactivation MAC CE according to the first embodiment has a variable size depending on the number of PUCCH resources sharing the same spatial relation.

The length of the PUCCH group spatial relation Activation/Deactivation MAC CE according to the first embodiment is 8*(N+2) including N+3 reserved bits, wherein N is the number of PUCCH resources sharing the same value of PUCCH-spatialRelationInfo. Incidentally, if 8 bits are used to indicate one PUCCH Resource, only 3 reserved bits are included. Accordingly, one MAC CE with 8*(N+2) bits (including N+3 reserved bits or 3 reserved bits) may be used to indicate or update N PUCCH resources with the same value of PUCCH-spatialRelationInfo.

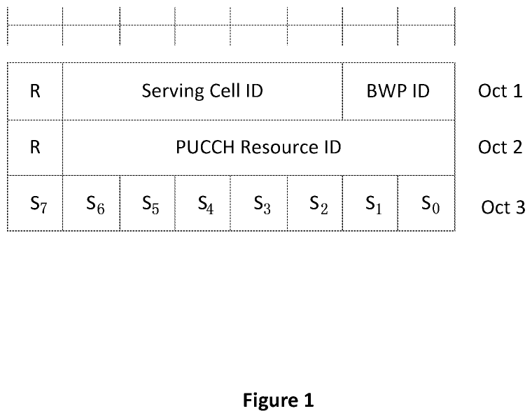

If the spatial relation of N PUCCH resources are indicated or updated with the prior art MAC CE shown in FIG. 1, N MAC CEs each with 80 bits (including 2 reserved bits) will be used. Note that FIG. 1 illustrates the MAC CE for indicating or updating a PUCCH with one of 8 possible PUCCH-spatialRelationInfo, in which the length is 24 bits. If 64 possible PUCCH-spatialRelationInfo may be indicated or updated, the length would be 80 bits.

According to the first embodiment, the PUCCH group is implicitly indicated. That is, all of the PUCCH resources (identified as PUCCH resource ID₁ to PUCCH resource ID_{N}) sharing the same value of PUCCH-spatialRelationInfo are implicitly indicated as a PUCCH group.

On the other hand, the PUCCH group may be explicitly indicated. According to a second embodiment, the maximum number of PUCCH resources (i.e. 128 PUCCH resources) that can be configured in a component carrier are configured as a PUCCH group, for example by higher layers.

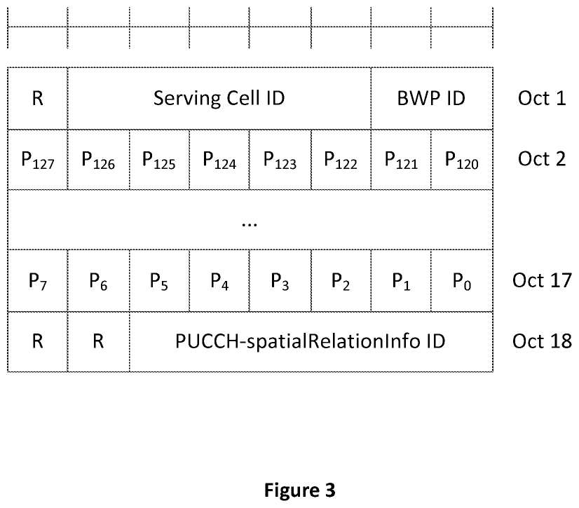

FIG. 3 illustrates an example of the PUCCH group spatial relation Activation/Deactivation MAC CE according to the second embodiment. The PUCCH spatial relation Activation/Deactivation MAC CE according to the second embodiment is identified by a dedicated MAC PDU sub-header.

The PUCCH group spatial relation Activation/Deactivation MAC CE according to the second embodiment has a fixed length of 144 bits with the following fields:

(1) Serving Cell ID: This field indicates the identity of the Serving Cell for which the MAC CE applies. The length of the field is 5 bits.

(2) BWP ID: This field indicates a UL BWP for which the MAC CE applies. The length of the BWP ID field is 2 bits.

(3) Pᵢ (i=0 . . . 127): If there is a PUCCH resource with pucch-ResourceId i as specified in TS 38.331 configured for the UL BWP by the BWP ID field, Pᵢ indicates the activation status of PUCCH resource with pucch-ResourceId i. The Pᵢ field is set to “1” to indicate PUCCH resource with pucch-ResourceId i should be activated with the PUCCH-spatialRelationInfo specified by the PUCCH-spatialRelationInfo ID. The Pᵢ field is set to “0” to indicate PUCCH resource with pucch-ResourceId i should be deactivated. One or more PUCCH resources (up to all of PUCCH resources indicated by Pᵢ, e.g. up to 128 shown in FIG. 3) can be active at a time. If pucch-ResourceId i is not specified in TS 38.331 configured for the UL BWP by the BWP ID field, MAC entity shall ignore this particular Pᵢ.

(4) PUCCH-spatialRelationInfo ID: this field indicates the identity of PUCCH-spatialRelationInfo as specified in TS 38.331 activated for the activated PUCCH resources by Pᵢ. That is, all of the PUCCH resources with Pᵢ fields that are set to “1” are activated with the PUCCH-spatialRelationInfo specified by this PUCCH-spatialRelationInfo ID. The length of this field is 6 bits, that is enough for indicating one of 64 spatial relations (i.e. the spatial relation to be indicated).

(5) R: Reserved bit. Each of the reserved bits is set to “0”.

According to the second embodiment, all of (up to 128) PUCCH resources with Pᵢ fields that are set to “1” can be indicated or updated with the value of PUCCH-spatialRelationInfo (identified by PUCCH-spatialRelationInfo ID) by one PUCCH group spatial relation Activation/Deactivation MAC CE as shown in FIG. 3 at a time.

The length of the PUCCH group spatial relation Activation/Deactivation MAC CE according to the second embodiment is fixed, i.e. 144 bits.

As the maximum number of spatial relations for PUCCH per BWP is 64 while a maximum of 128 PUCCH resources can be configured in a carrier for a UE, it is unlikely that up to 128 PUCCH resources share the same spatial relation. Therefore, the 128 PUCCH resources may be grouped in multiple PUCCH groups (i.e. more than one PUCCH group). For example, all PUCCH resources transmitted to one TRP panel may be defined as a PUCCH group.

According to a third embodiment, the 128 PUCCH resources are grouped into multiple PUCCH groups.

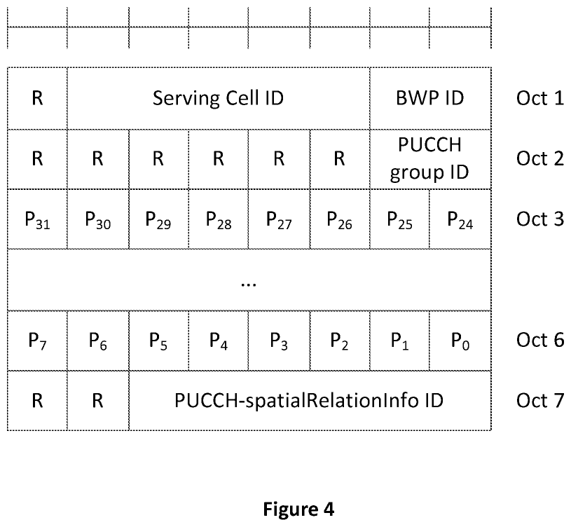

FIG. 4 illustrates an example of the PUCCH group spatial relation Activation/Deactivation MAC CE according to the third embodiment, in which 4 PUCCH groups are configured while each PUCCH group includes up to 32 PUCCH resources.

The PUCCH group spatial relation Activation/Deactivation MAC CE according to the third embodiment is identified by a dedicated MAC PDU sub-header. It has a fixed length of 56 bits for the situation shown in FIG. 4. The following fields are included:

(1) Serving Cell ID: This field indicates the identity of the Serving Cell for which the MAC CE applies. The length of the field is 5 bits.

(2) BWP ID: This field indicates a UL BWP for which the MAC CE applies The length of the BWP ID field is 2 bits.

(3) PUCCH group ID: this field indicates the identity of the PUCCH group for which the MAC CE applies. The length of the field is 2 bits for indicating 4 PUCCH groups. If other number of (other than 4) groups are configured, the length of this field may vary. For example, 1 bit is for 2 groups, 3 bits are for 8 groups, 4 bits are for 16 groups, 5 bits are for 32 groups, and 6 bits are for 64 groups.

(4) Pᵢ (i=0 . . . 31 in FIG. 4): Pᵢ indicates the activation status of the i^{th} PUCCH resource within the PUCCH group indicated by PUCCH group ID field. The Pᵢ field is set to “1” to indicate the i^{th} PUCCH resource within the PUCCH group indicated by PUCCH group ID field should be activated. The Pᵢ field is set to “0” to indicate the i^{th} PUCCH resource within the PUCCH group indicated by PUCCH group ID field should be deactivated. One or more PUCCH resources can be active at a time. The PUCCH resources (e.g. 128 PUCCH resources: PUCCH resource #0-PUCCH resource #127, i.e., PUCCH resources with IDs 0-127) may be sequentially grouped into the PUCCH groups. That is, the PUCCH resources with smaller PUCCH resource IDs may be grouped into PUCCH groups with smaller PUCCH group IDs. In addition, within the same PUCCH group, the PUCCH resources with smaller PUCCH resource IDs may be positioned in front of the PUCCH resources with larger PUCCH resource IDs. For example, if there are 4 PUCCH groups (PUCCH group #0-PUCCH group #3), PUCCH resource #0-PUCCH resource #31 would belong to PUCCH group #0; PUCCH resource #32-PUCCH resource #63 would belong to PUCCH group #1; PUCCH resource #64-PUCCH resource #95 would belong to PUCCH group #2; and PUCCH resource #96-PUCCH resource #127 would belong to PUCCH group #3.

(5) PUCCH-spatialRelationInfo ID: this field indicates the identity of PUCCH-spatialRelationInfo as specified in TS 38.331 activated for the listed PUCCH resources. That is, all of the PUCCH resources with Pᵢ fields that are set to “1” are activated with the PUCCH-spatialRelationInfo specified by this PUCCH-spatialRelationInfo ID. The length of this field is 6 bits, that is enough for indicating one of 64 spatial relations (i.e. the spatial relation to be indicated).

(6) R: Reserved bit. Each of the reserved bits is set to “0”.

According to the third embodiment, the PUCCH resources in one PUCCH group with Pᵢ fields that are set to “1” can be indicated or updated with the value of PUCCH-spatialRelationInfo (identified by PUCCH-spatialRelationInfo ID) by one PUCCH group spatial relation Activation/Deactivation MAC CE at a time.

For example, as shown in FIG. 4, four PUCCH groups are configured. Each PUCCH group includes up to 32 PUCCH resources. The up to 32 PUCCH resources contained in one PUCCH group with Pᵢ fields that are set to “1” can be indicated or updated with the value of PUCCH-spatialRelationInfo (identified by PUCCH-spatialRelationInfo ID) by one PUCCH group spatial relation Activation/Deactivation MAC CE shown in FIG. 4 at a time.

In particular, each PUCCH resource is indicated by both a PUCCH group ID and a Pᵢ field. When the PUCCH group ID indicates PUCCH group #0, P₀-P₃₁ indicate PUCCH resource #0-PUCCH resource #31 respectively; when the PUCCH group ID indicates PUCCH group #1, P₀-P₃₁ indicate PUCCH resource #32-PUCCH resource #63 respectively; when the PUCCH group ID indicates PUCCH group #2, P₀-P₃₁ indicate PUCCH resource #64-PUCCH resource #95 respectively; and when the PUCCH group ID indicates PUCCH group #3, P₀-P₃₁ indicate PUCCH resource #96-PUCCH resource #127 respectively.

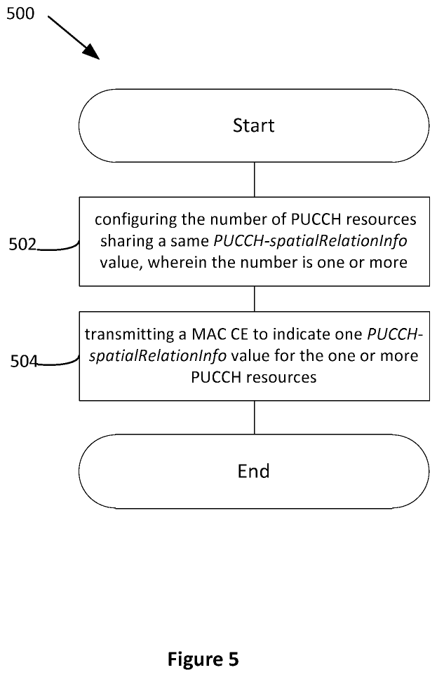

FIG. 5 is a schematic flow chart diagram illustrating an embodiment of a method 500 for configuring and indicating spatial relation for PUCCH resources. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may include 502 configuring the number of PUCCH resources sharing a same PUCCH-spatialRelationInfo value, wherein the number is one or more; and 504 transmitting a MAC CE to indicate one PUCCH-spatialRelationInfo value for the one or more PUCCH resources.

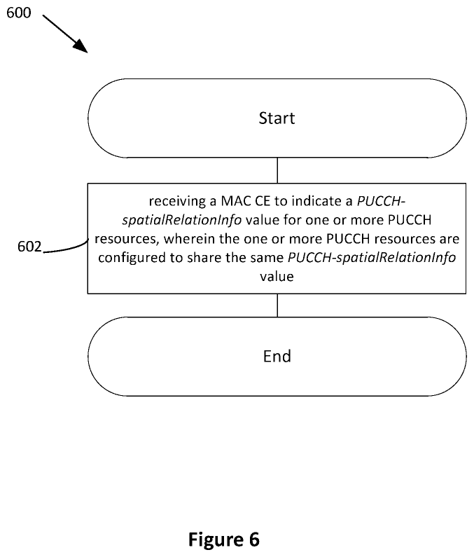

FIG. 6 is a schematic flow chart diagram illustrating an embodiment of a method 600 for configuring and indicating spatial relation for PUCCH resources. In some embodiments, the method 600 is performed by an apparatus, such as a remote unit (UE). In certain embodiments, the method 600 may be performed by a processor executing program code, for example, a microcontroller, a microprocessor, a CPU, a GPU, an auxiliary processing unit, a FPGA, or the like.

The method 600 may include 602 receiving a MAC CE to indicate a PUCCH-spatialRelationInfo value for one or more PUCCH resources, wherein the one or more PUCCH resources are configured to share the same PUCCH-spatialRelationInfo value.

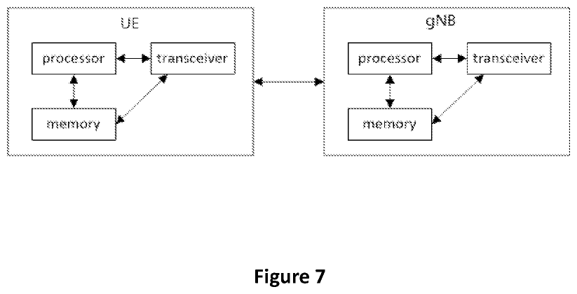

FIG. 7 is a schematic block diagram illustrating apparatuses according to one embodiment.

Referring to FIG. 7, the UE (i.e. the remote unit) includes a processor, a memory, and a transceiver. The processor implements a function, a process, and/or a method which are proposed in FIG. 6. The gNB (i.e. base unit) includes a processor, a memory, and a transceiver. The processors implement a function, a process, and/or a method which are proposed in FIG. 5. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1-24. (canceled)

25. An apparatus comprising:
one or more processors configured to indicate a spatial relation of one or more physical uplink control channel resources sharing a same PUCCH-spatialRelationInfo value; and
a transceiver configured to transmit a media access control control element to indicate the PUCCH-spatialRelationInfo value for the one or more physical uplink control channel resources.

26. The apparatus of claim 25, wherein, each physical uplink control channel resource is indicated by a 7-bit or 8-bit field in the media access control control element.

27. The apparatus of claim 25, wherein the one or more processors are further configured to configure one or more physical uplink control channel groups including the one or more physical uplink control channel resources, wherein each physical uplink control channel resource is indicated with 1 bit in the media access control control element.

28. The apparatus of claim 27, wherein when two or more physical uplink control channel groups are configured, the media access control control element includes a physical uplink control channel group identifier field to indicate an identity of the physical uplink control channel group for which the media access control control element applies.

29. The apparatus of claim 28, wherein each physical uplink control channel resource is indicated with a physical uplink control channel group identifier and 1 bit in the media access control control element, wherein the physical uplink control channel group identifier indicates a physical uplink control channel group, and the 1 bit indicates the physical uplink control channel resource identifier within the physical uplink control channel group.

30. The apparatus of claim 25, wherein the media access control control element comprises a serving cell identifier field with 5 bits, a bandwidth part identifier field with 2 bits, and a PUCCH-spatialRelationInfo identifier field with 6 bits.

31. The apparatus of claim 25, wherein the media access control control element comprises an activation/deactivation media access control control element identified by a media access control protocol data unit sub-header with a dedicated logical channel identifier.

32. An apparatus comprising:
a transceiver configured to receive a media access control control element indicating a PUCCH-spatialRelationInfo value for one or more physical uplink control channel resources, the one or more physical uplink control channel resources sharing a same PUCCH-spatialRelationInfo value; and
one or more processors configured to utilize the one or more physical uplink control channel resources in conjunction with wireless communication.

33. The apparatus of claim 32, wherein, each physical uplink control channel resource is indicated by a 7-bit or 8-bit field in the media access control control element.

34. The apparatus of claim 32, wherein one or more physical uplink control channel groups are configured to include the one or more physical uplink control channel resources, each physical uplink control channel resource is indicated with 1 bit in the media access control control element.

35. The apparatus of claim 34, wherein, when two or more physical uplink control channel groups are configured, the media access control control element includes a physical uplink control channel group identifier field to indicate an identity of the physical uplink control channel group for which the media access control control element applies.

36. The apparatus of claim 35, wherein each physical uplink control channel resource is indicated with a physical uplink control channel group identifier and 1 bit in the media access control control element, wherein the physical uplink control channel group identifier indicates a physical uplink control channel group, and the 1 bit indicates the physical uplink control channel resource identifier within the physical uplink control channel group.

37. The apparatus of claim 32, wherein the media access control control element contains a serving cell identifier field with 5 bits, a bandwidth part identifier field with 2 bits, and a PUCCH-spatialRelationInfo identifier field with 6 bits.

38. The apparatus of claim 32, wherein the media access control control element comprises an activation/deactivation media access control control element identified by a media access control protocol data unit sub-header with a dedicated logical channel identifier.

39. A method comprising:
configuring one or more physical uplink control channel resources sharing a same PUCCH-spatialRelationInfo value; and
transmitting a media access control control element to indicate the PUCCH-spatialRelationInfo value for the one or more physical uplink control channel resources.

40. The method of claim 39, wherein, each physical uplink control channel resource is indicated by a 7-bit or 8-bit field in the media access control control element.

41. The method of claim 39, further comprising configuring one or more physical uplink control channel groups including the one or more physical uplink control channel resources, wherein each physical uplink control channel resource is indicated with 1 bit in the media access control control element.

42. The method of claim 41, wherein when two or more physical uplink control channel groups are configured, the media access control control element includes a physical uplink control channel group identifier field to indicate an identity of the physical uplink control channel group for which the media access control control element applies.

43. The method of claim 42, wherein each physical uplink control channel resource is indicated with a physical uplink control channel group identifier and 1 bit in the media access control control element, wherein the physical uplink control channel group identifier indicates a physical uplink control channel group, and the 1 bit indicates the physical uplink control channel resource identifier within the physical uplink control channel group.

44. The method of claim 39, wherein the media access control control element contains a serving cell identifier field with 5 bits, a bandwidth part identifier field with 2 bits, and a PUCCH-spatialRelationInfo identifier field with 6 bits.
